(19) United States
(12) Patent Application Publication
(10) Pub. No.: US 2011/0052152 A1
(43) Pub. Date: Mar. 3, 2011

(54) RECORDER AND RECORDING METHOD

(76) Inventor: Tomotaka Ida, Kumagaya-shi (JP)

(21) Appl. No.: 12/753,603

(22) Filed: Apr. 2, 2010

(30) Foreign Application Priority Data
Aug. 31, 2009 (JP) 2009-200989

(51) Int. Cl. H04N 5/91; H04N 5/93; H04N 5/76; G11B 27/00

(52) U.S. Cl. 386/279; 386/297

(57) ABSTRACT

According to one embodiment, a recorder includes a recording module, a first display module, a selector, a second display module, and a processor. The recording module simultaneously records programs of a plurality of channels with a plurality of tuners. The first display module displays past program information indicating the programs simultaneously recorded by the recording module as past programs. The selector selects a past program, with respect to which a function related to the past program is to be performed, from the past programs indicated by the past program information. The second display module displays a selection screen containing an image for selecting the function to be performed with respect to the past program selected by the selector and information on the past program. The processor performs the function selected through the image on the selection screen with respect to the past program selected by the selector.

### CROSS-REFERENCE TO RELATED APPLICATIONS

This application is based upon and claims the benefit of priority from Japanese Patent Application No. 2009-200989, filed Aug. 31, 2009, the entire contents of which are incorporated herein by reference.

### BACKGROUND

1. Field

One embodiment of the invention relates to a recorder and a recording method.

2. Description of the Related Art Japanese Patent Application Publication (KOKAI) No. 2009-44442 discloses a conventional recorder that displays a list of recorded programs to allow the user to select a program from the list. When a program is selected, the conventional recorder displays an operation menu for selecting a function related to the selected program (hereinafter, “related function”), and perform the related function selected from the operation menu. The conventional recorder has such related functions as, for example, reproducing function for reproducing the selected program, timer recording function for scheduling the recording of a to-be-broadcasted program related to the selected program (e.g., a program of a television drama series), and the like.

If a recorder has the function of simultaneously recording programs of a plurality of channels using a plurality of tuners, the recorder may simultaneously record programs broadcasted during a specific time period such as prime time regardless of whether the user wishes to view the programs. In such a case, if the programs are displayed in a list, the list may contain a program on which the user has no intention to perform a related function. With the conventional recorder that displays only the operation menu when a program is selected from a list of programs, a related function may be erroneously performed with respect to a program not intended by the user.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a television (TV) according to an embodiment of the invention;

FIG. 2 is an exemplary functional block diagram of a controller in the embodiment;

FIG. 3 is an exemplary schematic diagram of a past program guide in the embodiment;

FIG. 4 is an exemplary schematic diagram of a selection window in the embodiment; and

FIG. 5 is an exemplary flowchart of the process of performing a related function with respect to a past program in the embodiment.

### DETAILED DESCRIPTION

Various embodiments according to the invention will be described hereinafter with reference to the accompanying drawings. In general, according to one embodiment of the invention, a recorder comprises a recording module, a first display module, a selector, a second display module, and a processor. The recording module is configured to simultaneously record programs of a plurality of channels with a plurality of tuners. The first display module is configured to display past program information indicating the programs simultaneously recorded by the recording module as past programs. The selector is configured to select a past program, with respect to which a function related to the past program is to be performed, from the past programs indicated by the past program information. The second display module is configured to display a selection screen containing an image for selecting the function to be performed with respect to the past program selected by the selector and information on the past program. The processor is configured to perform the function selected through the image on the selection screen with respect to the past program selected by the selector.

According to another embodiment of the invention, there is provided a recording method applied to a recorder. The recording method comprises: a recording module simultaneously recording programs of a plurality of channels with a plurality of tuners; a first display module displaying past program information indicating the programs simultaneously recorded by the recording module as past programs; a selector selecting a past program, with respect to which a function related to the past program is to be performed, from the past programs indicated by the past program information; a second display module displaying a selection screen containing an image for selecting the function to be performed with respect to the past program selected by the selector and information on the past program; and a processor performing the function selected through the image on the selection screen with respect to the past program selected by the selector.

In the following, the recorder and the recording method of the embodiments will be described as being applied to a television (TV). However, this is by way of example only and the recorder and the recording method may also be used in other applications.

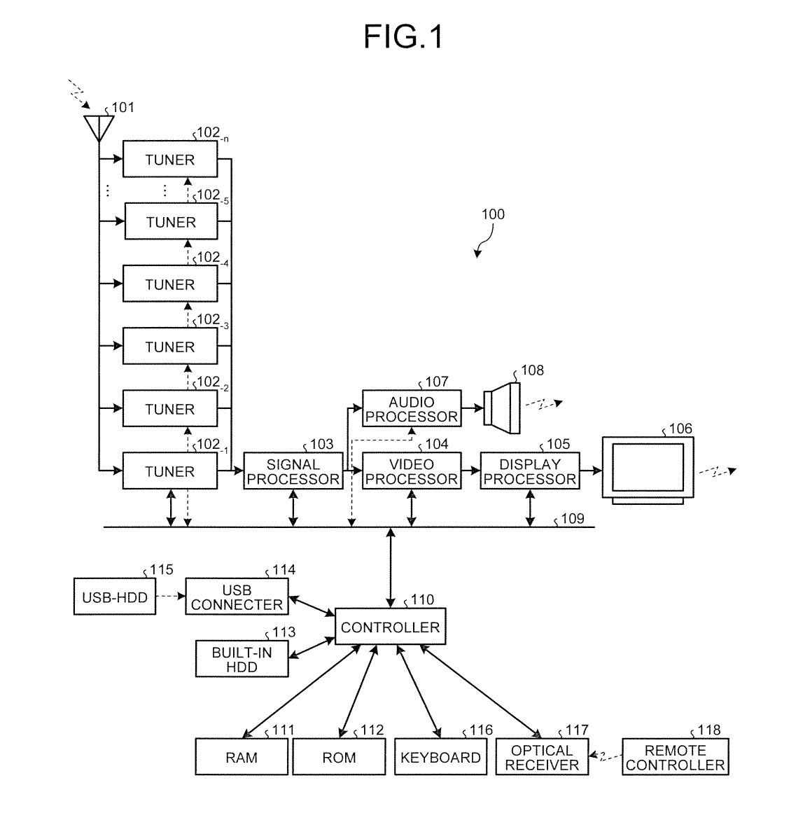

FIG. 1 is a block diagram of a TV 100 according to an embodiment of the invention. The TV 100 features tuners for receiving digital broadcasts. The TV 100 comprises an antenna 101, tuners 102₋₁ to 102₋ₙ, a signal processor 103, a video processor 104, a display processor 105, a display module 106, an audio processor 107, a speaker 108, a communication line 109, a controller 110, a random access memory (RAM) 111, a read only memory (ROM) 112, a built-in hard disk drive (HDD) 113, a universal serial bus (USB) connector 114, a keyboard 116, and an optical receiver 117.

The antenna 101 receives digital broadcasting such as ES broadcasting, CS broadcasting, and digital terrestrial broadcasting, and outputs it to the tuners 102₋₁ to 102₋ₙ. The tuners 102₋₁ to 102₋ₙ, selectively receive a broadcast signal of a channel specified by the user to view. The tuners 102₋₁ to 102₋ₙ, demodulate the broadcast signal and output it to the signal processor 103.

The signal processor 103 extracts separately a video signal, an audio signal, and other signals from the broadcast signal received from the tuners 102₋₁ to 102₋ₙ, and further extracts a desired signal from them. The signal processor 103 outputs the extracted video signal to the video processor 104 as well as outputting the extracted audio signal to the audio processor 107.

The video processor 104 adjusts the angle of view, color, and the like of an image represented by the video signal received from the signal processor 103 or the controller 110, and outputs the adjusted video signal to the display processor 105.

Upon receipt of the video signal from the video processor 104, the display processor 105 converts the video signal to a format displayable on the display module 106, and thereby displays the video signal on the display module 106. Besides, the display processor 105 generates an image signal for an electronic program guide (EPG), on screen display (OSD), or the like, and outputs it to the display module 106 together with the video signal. The display processor 105 of the embodiment generates an image signal for displaying an EPG in which programs of channels that can be picked up by the tuners 102₋₁ to 102₋ₙ, are arranged in time series.

Upon receipt of the audio signal received from the signal processor 103 or the controller 110, the audio processor 107 converts the audio signal to a format reproducible by the speaker 108, and outputs it to the speaker 108.

The controller 110 controls the tuners 102₋₁ to 102₋ₙ, the signal processor 103, the video processor 104, the display processor 105, and the audio processor 107. For a specific example, the controller 110 may be a microcomputer.

The communication line 109 connects the tuners 102₋₁ to 102₋ₙ, the signal processor 103, the video processor 104, the display processor 105, and the audio processor 107 to the controller 110 so that the controller 110 can exchange data with them. For a specific example, the communication line 109 may be an inter-integrated circuit (IIC) bus.

The RAM 111 and the POM 112 store various types of data and exchange the data with the controller 110.

The keyboard 116 is used by the user to provide various inputs or instructions to the TV 100. The optical receiver 117 receives a signal from a remote controller 118 in response to instruction from the user. The remote controller 118 comprises a numeric keypad for inputting digits 0 to 9, letters, and characters, a channel up key and a channel down key for selecting a channel, an arrow key for specifying up, down, left, or right, and a switch key for switching the type of broadcast displayed on the display module 106. The USB connecter 114 is used to connect a USB external storage device such as a USB-HDD 115 to the TV 100.

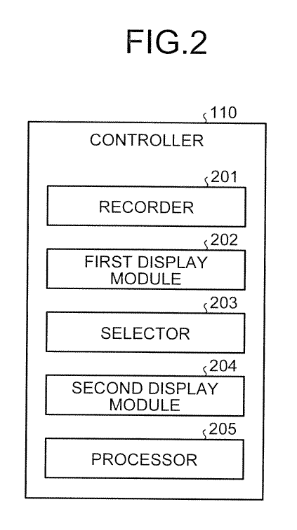

FIG. 2 is a functional block diagram of the controller 110. The controller 110 comprises a recorder 201, a first display module 202, a selector 203, a second display module 204, and a processor 205.

In response to a request to simultaneously record programs of a plurality of channels from the remote controller 118, the recorder 201 stores video and audio signals (hereinafter, “program data”) extracted by the signal processor 103 from broadcast signals of the channels received by the tuners 102₋₁ to 102₋ₙ in the built-in HDD 113, thereby simultaneously recording the programs of the channels received by the tuners 102₋₁ to 102₋ₙ. It is herein assumed that, upon receipt of a request for simultaneous recording from the remote controller 118, a time period is set for the simultaneous recording, and the recorder 201 simultaneously records programs of a plurality of channels during the time period.

Further, in response to the request for simultaneous recording from the remote controller 118, the recorder 201 obtains an image signal of an EPG listing the programs simultaneously recorded during the time period. The recorder 201 stores the image signal of the EPG in the built-in HDD 113 as past program guide data. The term “past program” as used herein refers to a program broadcasted in the past.

Upon receipt of a request to display a past program guide from the remote controller 118, the first display module 202 reads the past program guide data stored in the built-in HDD 113, and outputs it to the display module 106 through the display processor 105. Thus, the first display module 202 displays the past program guide as past program information indicating the past programs simultaneously recorded in the past on the display module 106.

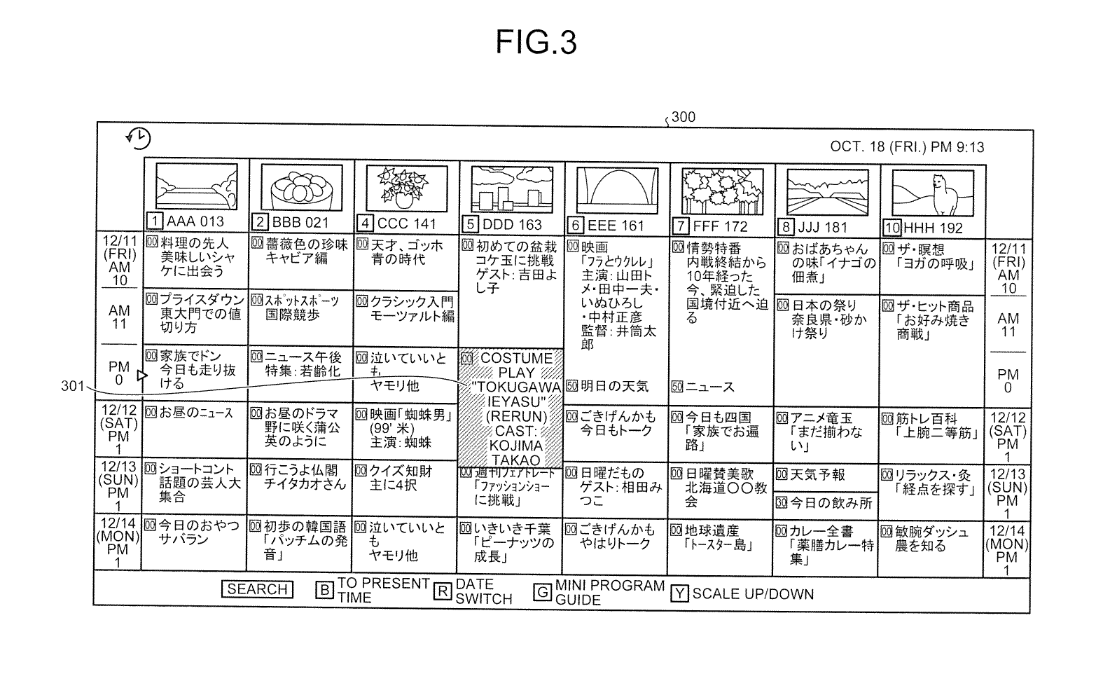

FIG. 3 illustrates an example of the past program guide. It is assumed herein that, as illustrated in FIG. 3, the first display module 202 displays a past program guide 300 listing only programs broadcasted during a time period in which simultaneous recording is performed without programs broadcasted during other time periods on the display module 106. That is, the first display module 202 displays the past program guide 300 that indicates only programs broadcasted during time periods in which simultaneous recording is performed closer together on the display module 106. While the past program guide is described above as not indicating programs broadcasted during a time period in which simultaneous recording is not performed, this is by way of example and not of limitation. For example, since programs broadcasted during a time period in which simultaneous recording is not performed are not available for reproduction, corresponding part of the past program guide may be displayed grayed out or the like to indicate that the programs cannot be reproduced.

In addition, while the past program guide 300, in which past programs are arranged in time series for each channel, is illustrated as an example of the past program information of the embodiment, the past program information is not so limited as long as it is capable of indicating the past programs. For example, if there is a detector that detects a specific past program (for example, a program broadcasted during a time period specified through the remote controller 118), the first display module 202 may display a list of past programs obtained as the detection result of the detector as the past program information.

The selector 203 selects, from past programs indicated by the past program guide displayed on the display module 106, a past program with respect to which a related function is to be performed. The term “related function” as used herein refers to a function related to the past program such as, for example, reproducing function for reproducing the past program, dubbing function for dubbing the past program to another storage device (for example, the USB-HDD 115), delete function for deleting the past program, timer recording function for scheduling the recording of a to-be-broadcasted program related to the past program (e.g., a program of a television drama series), or the like.

When the user places a cursor 301 on one of the past programs indicated by the past program guide 300 displayed on the display module 106 using the arrow key and presses the enter key on the remote controller 118, the selector 203 of the embodiment selects the past program so that a related function is to be performed with respect to the past program.

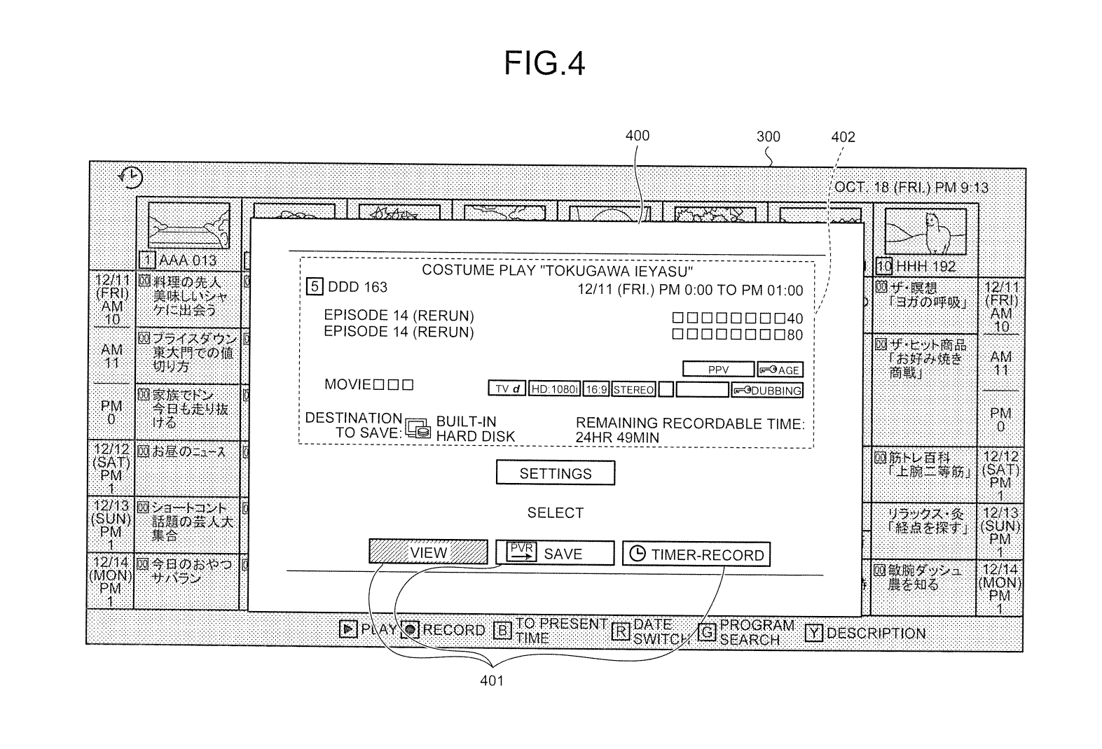

The second display module 204 displays a selection window 400 (see FIG. 4) on the display module 106 through the display processor 105. The selection window 400 displays OSD buttons 401 for selecting a related function to be performed on the past program selected by the selector 203 with the OSD function and program information 402 as information on the selected past program. The program information 402 includes the program name, the broadcast station, the broadcast date and time, a brief description of the past program, and the like.

FIG. 4 illustrates an example of the selection window 400. It is assumed herein that, as illustrated in FIG. 4, the second display module 204 displays the selection window 400 to be overlaid on the past program guide 300 displayed on the display module 106. In the selection window 400, one of the OSD buttons 401 indicating “Save” is used to select the dubbing function, while the OSD button 401 indicating “Timer-Record” is used to select the timer recording function. Among the OSD buttons 401 displayed on the selection window 400, the second display module 204 displays the one corresponding to a related function that is not available for the selected past program in the current system status as grayed out. For example, if a past program other than the past program selected by the selector 203 is being dubbed, the selected past program cannot be dubbed. Accordingly, the second display module 204 displays, among the OSD buttons 401 displayed on the selection window 400, the one used to select the dubbing function as grayed out.

When one of the OSD buttons 401 is selected with the arrow key and the enter key on the remote controller 118, the processor 205 performs a related function corresponding to the selected one of the OSD buttons 401 with respect to the past program selected by the selector 203.

For example, when one of the OSD buttons 401 indicating “View” is selected, the processor 205 performs the reproducing function. More specifically, the processor 205 detects the head of the past program selected by the selector 203, i.e., the start time of the recording of the past program, from past program data stored in the built-in HDD 113. The processor 205 reads the program data from the detected time, and outputs it to the video processor 104 and the audio processor 107 to thereby reproduce the past program. Incidentally, if the past program selected by the selector 203 is already being reproduced, the processor 205 reproduces the past program from the middle thereof.

Meanwhile, when one of the OSD buttons 401 indicating “Save” is selected, the processor 205 performs the dubbing function. More specifically, the processor 205 displays a setting window for setting where the past program is to be dubbed or a dubbing destination (for example, the USB-HDD 115) on the display module 106 through the display processor 105. If there is only one dubbing destination, the processor 205 displays a warning indicating that no option is available in the setting window. After the dubbing destination is set in the setting window, the processor 205 displays an image on the display module 106 through the display processor 105 to ask the user to confirm that the past program is to be dubbed. Examples of such an image include a “Yes” button to instruct to perform the dubbing and a “No” button to cancel the dubbing. If the “Yes” button is pressed, the processor 205 performs the dubbing. On the other hand, if the “No” button is pressed, the processor 205 cancels the dubbing. The processor 205 of the embodiment stores the program data in the USB-HDD 115 through the USB connector 114 to dub the past program.

When one of the OSD buttons 401 indicating “Timer-Record” is selected, the processor 205 performs the timer recording function. More specifically, for example, the processor 205 schedules the recording of a program with the same program name as the past program selected by the selector 203 among programs to be broadcasted or programs on the EPG generated by the display processor 105. The program to be timer-recorded may be another episode than the past program in a drama series.

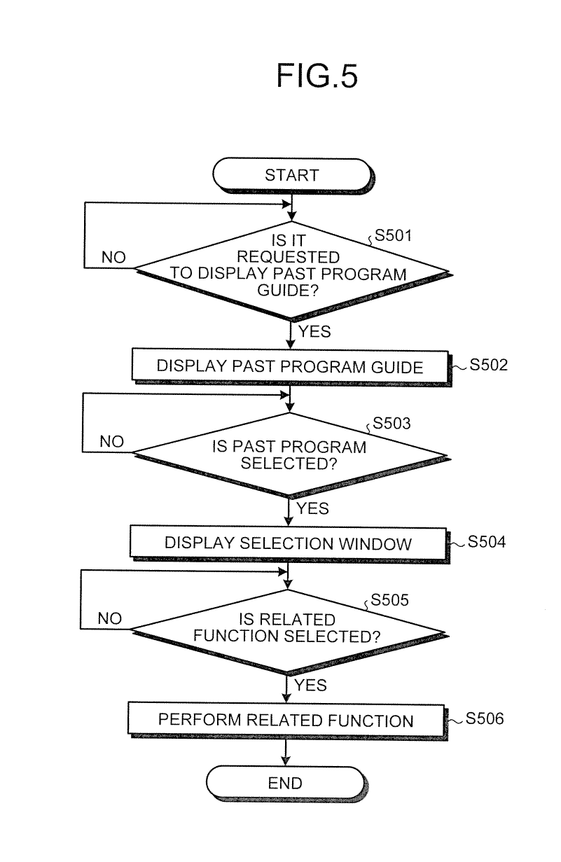

With reference to FIG. 5, a description will be given of the process of performing a related function with respect to a past program. FIG. 5 is a flowchart of the process of performing a related function with respect to a past program.

The first display module 202 waits for a request to display the past program guide 300 from the remote controller 118 (S501). Upon receipt of a request to display the past program guide 300 from the remote controller 118 (Yes at S501), the first display module 202 displays the past program guide 300 on the display module 106 (S502).

When the past program guide 300 is displayed on the display module 106, the selector 203 waits for that a past program is selected from the past program guide 300 by using the arrow key and the enter key on the remote controller 118 to perform a related function thereon (S503).

When the cursor 301 is placed on a past program by the arrow key and the enter key is pressed on the remote controller 118 (Yes at S503), the selector 203 selects the past program pointed by the cursor 301 as the one with respect to which a related function is to be performed. The second display module 204 displays the selection window 400 to be overlaid on the past program guide 300 displayed on the display module 106 (S504). The selection window 400 displays the OSD buttons 401 for selecting a related function to be performed on the selected past program and the program information 402 as information on the selected past program.

After that, when one of the OSD buttons 401 is pressed (Yes at S505), the processor 205 performs a related function corresponding to the OSD button 401 with respect to the past program selected by the selector 203 (S506).

As described above, according to the present invention, the TV 100 is capable of simultaneously recording programs of a plurality of channels received by the tuners 102₋₁ to 102₋ₙ. The past program guide 300 is displayed to indicate the simultaneously recorded programs as past programs so that the user can select one of the past programs therefrom with respect to which a related function is to be performed. The selection window 400 displays the OSD buttons 401 for selecting a related function to be performed with respect to the selected past program and the program information 402 as information on the selected past program. When one of the OSD buttons 401 is pressed in the selection window 400, a related function corresponding to the OSD button 401 is performed with respect to the selected past program. The user can check the program information 402 before pressing the OSD button 401 in the selection window 400. Thus, the related function can be performed accurately with respect to each of the simultaneously recorded programs.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recorder comprising:
a recording module configured to simultaneously record programs of a plurality of channels with a plurality of tuners;
a first display module configured to display past program information indicating the programs simultaneously recorded by the recording module as past programs;
a selector configured to select a past program, with respect to which a function related to the past program is to be performed, from the past programs indicated by the past program information;
a second display module configured to display a selection screen containing an image for selecting the function to be performed with respect to the past program selected by the selector and information on the past program; and
a processor configured to perform the function selected through the image on the selection screen with respect to the past program selected by the selector.

2. The recorder of claim 1, wherein the first display module is configured to display a past program guide, in which the past programs are arranged in time series, as the past program information.

3. The recorder of claim 1, further comprising a detector configured to detect a specific past program from the past programs, wherein
the first display module is configured to display the past program information indicating a list of past programs detected by the detector.

4. The recorder of claim 1, wherein the function is function of reproducing the past program.

5. The recorder of claim 1, wherein the function is function of dubbing the past program to an external storage device.

6. The recorder of claim 1, wherein the function is function of scheduling recording of a program related to the past program among programs to be broadcasted.

7. A recording method applied to a recorder, comprising:
a recording module simultaneously recording programs of a plurality of channels with a plurality of tuners;
a first display module displaying past program information indicating the programs simultaneously recorded by the recording module as past programs;
a selector selecting a past program, with respect to which a function related to the past program is to be performed, from the past programs indicated by the past program information;
a second display module displaying a selection screen containing an image for selecting the function to be performed with respect to the past program selected by the selector and information on the past program; and
a processor performing the function selected through the image on the selection screen with respect to the past program selected by the selector.

8. The recording method of claim 7, wherein the first display module displaying includes displaying a past program guide, in which the past programs are arranged in time series, as the past program information.

9. The recording method of claim 7, further comprising a detector detecting a specific past program from the past programs, wherein
the past program information indicates a list of past programs detected by the detector.
